(19) United States
(12) Patent Application Publication
(10) Pub. No.: US 2002/0040763 A1
(43) Pub. Date: Apr. 11, 2002

(54) Polyureas based on IPDI, HDI, their isocyanurates and amines

(75) Inventors: Werner Grenda, Herne (DE); Joern Volker Weiss, Haltern (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Degussa AG, Duesseldorf (DE)

(21) Appl. No.: 09/939,686

(22) Filed: Aug. 28, 2001

(30) Foreign Application Priority Data
Aug. 29, 2000 (DE) 10042322.1

(51) Int. Cl. C09J 4/00

(52) U.S. Cl. 156/331.7

(57) ABSTRACT

A polyurea, comprising the reaction product of isophorone diisocyanate (IPDI), hexamethylene diisocyanate (HDI), isocyanurates thereof and combinations of these materials with amines, the polyurea having a NCO/NH₂ ratio of 0.9 to 1.1 to 1 and an average molecular weight of at least 5000.

### BACKGROUND OF THE INVENTION

1. Field of the Invention

The present invention relates to novel polyureas based on isophorone diisocyanate (IPDI), hexamethylene diisocyanate (HDI) and/or their isocyanurate and amines, in particular isophorone diamine (IPD).

2. Description of the Background

Polyureas are well known and are employed in the following technical areas as adhesives: wood and paper, foamed materials and resins for paints and coatings (Houben-Weyl E 20/2 (1987), pp. 1721-1751; Houben-Weyl MV/2 (1963), pp. 165-171). However, a need exists for polyureas which are stable and useful in powder coatings.

### SUMMARY OF THE INVENTION

Accordingly, one object of the present invention is to provide polyureas which remain stable in solid form at curing temperatures ranging from 150 to 220° C., which is standard for powder coatings, without releasing significant quantities (≦2%) of organic materials or water.

Briefly, this object and other objects of the present invention as hereinafter will become more readily apparent can be attained by polyureas prepared by reacting isophorone diisocyanate (IPDI), hexamethylene diisocyanate (HDI), the isocyanurates thereof with amines, the polyureas having a NCO/NH₂ ratio of 0.9 to 1.1 to 1 and an average molecular weight of at least 5000.

### DETAILED DESCRIPTION OF THE PREFERRED EMBODIMENTS

The polyureas of the invention are prepared by reacting isophorone diisocyanate (IPDI), hexamethylene diisocyanate (HDI) with amines. Isophorone diamine (IPD) is preferred as an amine reactant. The IPDI and/or HDI reactant can be used either as a diisocyanate or as in the form of the isocyanurate. Mixtures of both these isocyanates or their isocyanurates are also advantageous.

All aliphatic, (cyclo)aliphatic, cycloaliphatic and aromatic diamines and/or polyamines (C5-C18), preferably isophorone diamine (IPD), may be used as amine reactants within the scope of the invention.

In general, polyureas having an NCO/NH₂ ratio of 0.9 to 1.1 to 1 are prepared. Solid and brittle polymers with a maximum degree of crosslinking, which melt only above 240° C. with decomposition and are insoluble in solvents, are prepared with the addition of equimolar quantities having an NCO/NH₂ ratio of 1 to 1.

Preferred polyureas within the scope of the present invention are those prepared by reacting IPD with IPDI isocyanurate and/or HDI isocyanurate and mixtures thereof.

Another aspect of the present invention is a process for manufacturing polyureas by the reaction of IPDI and/or HDI with amines, in particular IPD, wherein the amine is employed in a solvent such as toluol, to which isocyanate, also diluted with a solvent, if required, is added with stirring. For complete conversion the reaction mixture is heated for 2 to 3 hours in refluxing solvent. The reaction medium is then cooled, and the resulting polymer is separated (filtration) and then dried for 3 to 6 hours at 130 to 170° C. in a vacuum.

The polyureas of the present invention can be used as raw materials in the paint industry, in particular for manufacturing lacquers, paints and coatings.

Having now generally described this invention, a farther understanding can be obtained by reference to certain specific examples which are provided herein for purposes of illustration only and are not intended to be limiting unless otherwise specified.

General Process of Synthesis

A 70 g amount of IPD, diluted in 1000 ml toluol, is placed in a 2-liter three-necked flask fitted with stirrer, drip funnel and heating mantle. The equivalent (NH₂: NCO=1:1) quantity of the corresponding isocyanate or a mixture, diluted with the same quantity of toluol, is then gradually added dropwise to the amine solution. After addition of the isocyanate reactant, the reaction mixture is heated for 2 hours under reflux. After cooling the reaction solution to ambient temperature the corresponding solid (polyurea) is then filtered and dried in a vacuum (3 to 6 hours at 130 to 170° C.).

Polyurea examples (Data in parts by weight)

| | IPD | IPDI | IPDI trimer¹⁾ | HDI trimer²⁾ |
|---|---|---|---|---|
| PH-1 | 70 | — | 183 | — |
| PH-2 | 70 | — | — | 138 |
| PH-3 | 70 | 61 | 61 | — |
| PH-4 | 70 | — | 91 | 69 |

¹⁾VESTANAT T 1890, Degussa-Huls AG
²⁾DESMODUR N 330, Bayer AG

All products are white/colorless, brittle solids which are insoluble in standard solvents and melt only above 240° C. with decomposition.

When using the above-described polyureas in powder coatings, for example, it is an advantage to grind the products and screen them to <100 μm.

The disclosure of German priority application Serial Number 10042322.1 filed Aug. 29, 2000 is hereby incorporated by reference into the present application.

Obviously, numerous modifications and variations of the present invention are possible in light of the above teachings. It is therefore to be understood that within the scope of the appended claims, the invention may be practiced otherwise than as specifically described herein.

What is claimed as new and is intended to be secured by Letters Patent is:

1. A polyurea, comprising the reaction product of isophorone diisocyanate (IPDI), hexamethylene diisocyanate (HDI), isocyanurates thereof and combinations of these materials with amines, the polyurea having a NCO/NH₂ ratio of 0.9 to 1.1 to 1 and an average molecular weight of at least 5000.

2. The polyurea as claimed in claim 1, prepared from IPDI and isophorone diamine (IPD).

3. The polyurea as claimed in claim 1, prepared from the isocyanurate of the IPDI and IPD.

4. The polyurea as claimed in claim 1, prepared by reacting a mixture of IPDI and IPDI isocyanurate with IPD.

5. The polyurea as claimed in claim 1, prepared by reacting HDI and IPD.

6. The polyurea as claimed in claim 1, prepared by reacting the isocyanurate of HDI and IPD.

7. The polyurea as claimed in claim 1, prepared by reacting a mixture of HDI and HDI isocyanurates with IPD.

8. The polyurea as claimed in claim 1, prepared by reacting a mixture of IPDI isocyanurate and HDI isocyanurate with IPD.

9. The polyurea as claimed in claim 1, which is solid and is insoluble in solvents.

10. A process for preparing polyureas as claimed in claim 1, comprising:
reacting IPDI, HDI, their isocyanurates and mixtures thereof with amines in a solvent, to which isocyanate also diluted optionally with a solvent, is added with stirring;
heating the reaction medium for 2 to 3 hours in refluxing solvent and then cooling the reaction medium; and
separating the resulting polymer and then drying the polymer for 3 to 6 hours at 130 to 170° C. in a vacuum.

11. A method of preparing paint, comprising:
formulating the paint with the polyurea as claimed in claim 1 as a component of the paint.

12. A method of preparing lacquers and coatings, comprising:
formulating the lacquers and coatings with the polyurea as claimed in claim 1 as a component of the lacquers and coatings.
